(19) United States
(12) Patent Application Publication
(10) Pub. No.: US 2016/0071039 A1
(43) Pub. Date: Mar. 10, 2016

(54) Requirement Analysis and Conflict Resolution

(71) Applicants: Anitha Puttappa Chandrappa, Erlangen (DE); Anand Kumar Jha, Bangalore (IN); Mandar Mutalikdesai, Bangalore (IN); Deepti Savio, Bangalore (IN)

(72) Inventors: Anitha Puttappa Chandrappa, Erlangen (DE); Anand Kumar Jha, Bangalore (IN); Mandar Mutalikdesai, Bangalore (IN); Deepti Savio, Bangalore (IN)

(21) Appl. No.: 14/476,910

(22) Filed: Sep. 4, 2014

(51) Int. Cl. G06Q 10/06

(52) U.S. Cl. CPC G06Q 10/06313

(57) ABSTRACT

A method and system for analyzing one or more requirements at one or more levels of abstraction of a project is disclosed. The method includes an act of plotting one or more dependency graphs from the one or more requirements at the one or more levels of abstraction and an act of determining vulnerability and influence of the one or more requirements from the one or more dependency graphs. In a further act, one or more vulnerability scores and one or more influence scores are for the one or more requirements are evaluated from the vulnerability and the influence of the one or more requirements. In a further act, one or more volatile scores for the one or more requirements are determined from the one or more vulnerability scores and the one or more influence scores.

### TECHNICAL FIELD

The present embodiments relate to methods and systems for requirement analysis and conflict resolution and, more particularly, to methods and systems for identifying volatility, influence, vulnerability, and importance factors of project requirements.

### BACKGROUND

Requirements for a system, product, service, or any type of engineering project, referred as project hereafter, are stated at various levels of abstraction of the project, and from the perspectives of stakeholders involved in the project. For instance, initially a customer or client specifies requirements at a high abstract level, without any specific details. A project team, in conjunction with the client, breaks down the high abstract level requirements into more detailed specifications commonly known as market requirements specifications (MRS). The MRS is considered as the baseline document by the project team to specify detailed functional requirements specifications (FRS) followed by system/software requirements specifications (SRS).

Requirements volatility is the tendency of the requirements of a project to change over time in response to the dynamically evolving needs of customers, stakeholders, organization, and/or the work environment. Change in requirements has an impact on the existing requirements. In other words, when a requirement changes at a level of abstraction during a product development process, then the change in the requirement also influences other requirements at the same level of abstraction. Hence, the requirements volatility is an important risk for the project success that may occur at any level of abstraction during the product development process. Identifying the impact of requirement volatility on the other requirements and measuring the influence of the changed requirements on the existing requirements is a challenge in all kind of projects.

In the state of the art, various requirement management tools are known that demonstrate an impact of changed requirements on the existing requirements through a tracing mechanism where all the requirements are highlighted that are influenced by the changed requirement. But the requirement management tools fail in quantifying an influencing factor of the changed requirement and also a cascading effect of the changed requirement on the requirements that are not directly linked. The problem becomes even bigger when dealing with large scale projects where there are tens of thousands of requirements that are connected to each other in a spaghetti way. It becomes extremely difficult to predict an influence on the project when one requirement changes. Hence, to identify volatility along with an importance factor of a requirement at any point of time during the development process is an important aspect for a project.

It is evident from the foregoing that identifying volatility and quantifying an importance factor for each requirement of a project at various levels of abstraction, is important for the success of the project.

### SUMMARY AND DESCRIPTION

It is therefore an object of the present embodiments to provide a method and a system for analyzing requirements of a project at various levels of abstraction and identifying requirements volatility thereof.

The scope of the present invention is defined solely by the appended claims and is not affected to any degree by the statements within this summary. The present embodiments may obviate one or more of the drawbacks or limitations in the related art.

In a first aspect, a method for analyzing one or more requirements at one or more levels of abstraction of a project is disclosed. The method includes an act of plotting one or more dependency graphs from the one or more requirements at the one or more levels of abstraction and an act of determining vulnerability and influence of the one or more requirements from the one or more dependency graphs. In a further act, one or more vulnerability scores and one or more influence scores for the one or more requirements are evaluated from the vulnerability and the influence of the one or more requirements. In a further act, one or more volatile scores for the one or more requirements are determined from the one or more vulnerability scores and the one or more influence scores.

In accordance with the first aspect, the method further includes an act of receiving the one or more requirements and dependency data from at least one user.

Further, in accordance with the first aspect, the method further includes an act of evaluating an adjacent matrix and a transpose of the adjacent matrix for the one or more dependency graphs for evaluating the one or more vulnerability scores and the one or more influence scores.

Furthermore, in accordance with the first aspect, the method further includes an act of comparing the one or more vulnerability scores with a predefined threshold limit of vulnerability score for the project. The method also includes comparing the one or more influence scores with a predefined threshold limit of influence score for the project before determining the one or more volatile score for the one or more requirements.

In a second aspect, a system for analyzing one or more requirements at one or more levels of abstraction of a project is disclosed. The system disclosed as the second aspect includes one or more plotters for plotting one or more dependency graphs from the one or more requirements at the one or more levels of abstraction, one or more processors for determining vulnerability and influence of the one or more requirements from the one or more dependency graphs, and one or more iteration modules for evaluating one or more vulnerability scores and one or more influence scores for the one or more requirements.

In accordance to the second aspect, the one or more processors also evaluate an adjacent matrix and a transpose of the adjacent matrix for the one or more dependency graphs.

In a third aspect, a method for determining abstraction level specific importance of one or more requirements of a project is disclosed. The method includes an act of plotting one or more dependency graphs from the one or more requirements at the one or more levels of abstraction. The method also includes an act of determining one or more eigenvector centralities, one or more closeness scores, and one or more betweenness centralities for the one or more requirements from the one or more dependency graphs. In a further act, one or more aggregate measures of importance for the one or more requirements are evaluated from the one or more eigenvector centralities, the one or more closeness scores, and the one or more betweenness centralities.

In accordance to the third aspect, the method further includes an act of finding a shortest path between a first requirement of the one or more requirements and a second requirement of the one or more requirements from the one or more dependency graphs before determining the one or more closeness scores.

Further in accordance to the third aspect, the method further includes an act of identifying number of shortest path passing through a requirement of the one or more requirements from the one or more dependency graphs before determining the one or more betweenness centralities.

Furthermore in accordance to the third aspect, the method further includes an act of defining one or more tunable parameters before evaluating the one or more aggregate measures of importance for the one or more requirements.

Accordingly, the present embodiments provide methods and systems for analyzing the one or more requirements at the one or more levels of abstraction of the project.

### BRIEF DESCRIPTION OF THE DRAWINGS

FIG. 1 depicts a requirement dependency graph in accordance with an embodiment.

FIG. 2 depicts a requirement analysis system in accordance with an embodiment.

FIG. 3 depicts a flowchart for determining importance of project requirements in accordance with an embodiment.

### DETAILED DESCRIPTION

Various embodiments are described with reference to the drawings, where like reference numerals are used to refer to like elements throughout. In the following description, for purpose of explanation, numerous specific details are set forth in order to provide a thorough understanding of one or more embodiments. It may be evident that such embodiments may be practiced without these specific details.

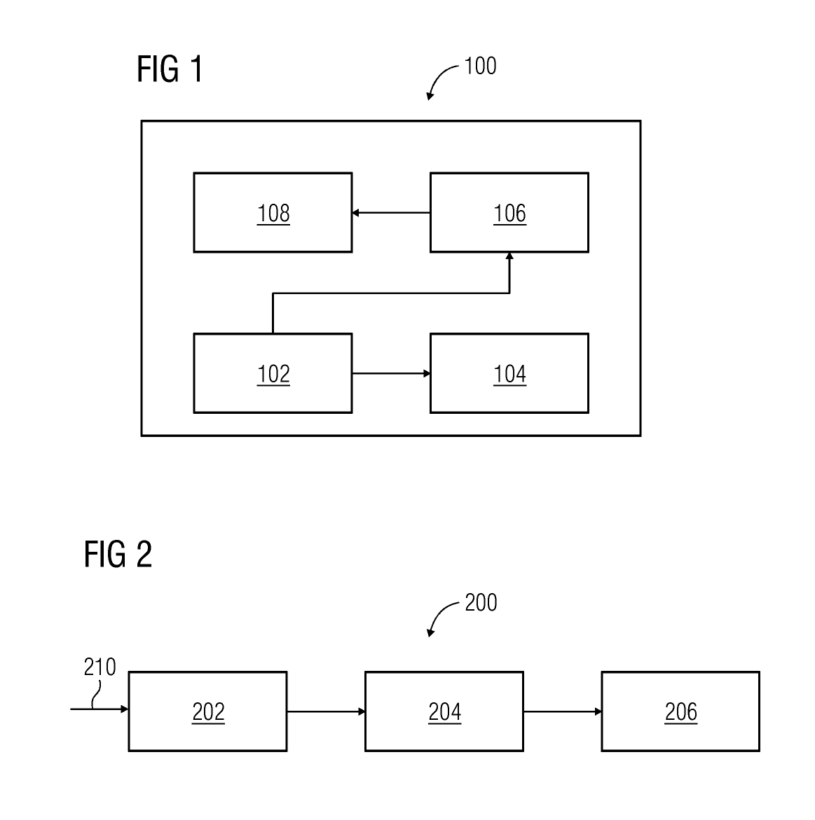

Referring to FIG. 1, a requirement dependency graph 100 in accordance with an embodiment is depicted. The requirement dependency graph 100 represents mutual dependency of one or more requirements at a level of abstraction of a project. FIG. 1 depicts the requirement dependency graph 100 includes four requirements 102, 104, 106, and 108. The requirement 102 is dependent on the requirement 104 and the requirement 106, e.g., the requirements 104 and 106 influence the requirement 102. In other words, the requirement 104 is an influencer for the requirement 102 that may be termed as vulnerable for the requirement 104. Similarly, the requirement 106 is also an influencer for the vulnerable requirement 102. FIG. 1 also depicts that the requirement 108 is an influencer for the requirement 106 that is vulnerable for the requirement 108. The requirement dependency graph 100 depicted in FIG. 1 is an exemplary representation of the dependency graph. In another embodiment, the requirement dependency graph 100 may include any number of requirements and the requirement dependency graph 100 may be created for all or few levels of abstraction. The levels of abstraction may include, but are not limited to, feature specification level, architect level, developer level, tester level, and so on.

The objective of creating the requirement dependency graph 100 at a level of abstraction is to identify the mutual dependency of requirements and also identify the influencer and vulnerable requirement pairs like requirement 102 and requirement 104 pair as depicted in FIG. 1.

FIG. 2 depicts a requirement analysis system 200 for modelling and quantifying influence and vulnerability of requirements, in accordance with an embodiment. The requirement analysis system 200 includes a plotter 202, a processor 204, and an iteration module 206, as depicted in FIG. 2. The plotter 202 receives one or more requirements at a level of abstraction of a project from one or more users through a connection 210. The plotter 202 also receives other inputs like dependency data from the one or more users. The dependency data includes, but is not limited to, information related to mutual dependency of the one or more requirements. The plotter 202 plots a dependency graph from the received inputs, e.g., the one or more requirements and the dependency data. The exemplary dependency graph 100 is depicted in FIG. 1.

The processor 204 receives input from the plotter 202, as depicted in FIG. 2. The processor 204 receives information of the one or more requirements in the form of influencer and vulnerable requirements, e.g., which requirement from the one or more requirements is an influencer requirement and which requirement from the one or more requirements is a vulnerable requirement. In addition, the processor 204 also receives information of each influencer requirement for a particular vulnerable requirement and each vulnerable requirement for a particular influencer requirement from the plotter 202. The processor 204 evaluates an influence score and a vulnerability score from the information received from the plotter 202. Assuming the dependency graph 100, as depicted in of FIG. 1, is sent as input to the processor 204 by the plotter 202. It is described in FIG. 1 that the requirement 104 and the requirement 106 influence the requirement 102. In addition, the requirement 106 is vulnerable to the requirement 108. From the dependency graph 100, the processor 204 evaluates the influence and the vulnerability scores. For the exemplary dependency graph 100, the vulnerability score of the requirement 102 (e.g., Vulnerability (102)), may be two as the requirement 102 is influenced by the requirements 104 and 106. Similarly, the influence score of the requirement 104, (e.g., Influence (104)), may be one as the requirement 104 is influencing only the requirement 102, as depicted in FIG. 1.

The processor 204 evaluates a vector X that represents the influence scores for the one or more requirements and a vector Y that represents the vulnerability scores for the one or more requirements by using following equation 1 and equation 2:

X=E*Y (1)

Y=T*X (2)

In equation 1, E represents an adjacent matrix representing the dependency graph received by the processor 204 from the plotter 202. For the exemplary dependency graph 100 of FIG. 1, the requirement 106 is dependent on the requirement 108 hence the adjacent matrix E for requirements 106 and 108 is evaluated as E [106,108]=1, otherwise 0. T of equation 2 represents a transpose of the adjacent matrix E. By substituting vector Y in the equation 1 from the equation 2 and vector X in the equation 2 from the equation 1, the following equations 3 and 4 are formed:

X=E*T*X (3)

Y=T*E*Y (4)

From equations 3 and 4, the vector X converges to principal eigenvector ET and the vector Y converges to principal eigenvector TE.

Equations 3 and 4 are power iterations; hence, the processor 204 sends mathematical representations of equation 3 and equation 4 to the iteration module 206, as depicted in FIG. 2. The iteration module 206 receives the mathematical representations of equation 3 and equation 4 and computes the vector X and the vector Y by iterating equation 3 and equation 4. The iteration module 206 computes the vector X and the vector Y by using one or more iteration methods known in the state of the art.

Based on the values of the vector X, (e.g., the influence score), and the vector Y, (e.g., vulnerability score) computed by the requirement analysis system 200, volatility of the one or more requirements is defined. In an exemplary embodiment, a highly vulnerable requirement of a project includes an influence score that is less than a predefined threshold limit of influence score for the project, but higher than a predefined threshold limit of vulnerability score for the project. Similarly, a highly influential requirement of the project includes an influence score that is higher than the predefined threshold limit of influence, but less than a predefined threshold limit of vulnerability score.

However, a requirement from the one or more requirements of the project that has acquired an influence score and a vulnerability score higher than the predefined thresholds of the influence and the vulnerability score, respectively, than the requirement will be considered as highly volatile requirement. On the other hand, if an influence score and a vulnerability score is less than the predefined thresholds of the influence and the vulnerability score, respectively, for a requirement of the project than the requirement will be considered as a regular requirement. In other embodiments, a framework for classifying the one or more requirements under different categories based on the influence scores and the vulnerability scores may vary. Any framework for classifying the one or more requirements under various categories that is known to a person ordinarily skilled in the art may be used.

Requirements from the one or more requirements of the project having high influence scores and high vulnerability scores are considered to be volatile for the project. The volatile requirements may be quantified by using following equation 5:

v[r]=(X[r]+Y[r]/(|X[r]−Y[r]|+1) (5)

In the equation 5, v represents a volatile score for the requirement r. X[r] and Y[r] represent the influence score and the vulnerability score for the requirement r, respectively.

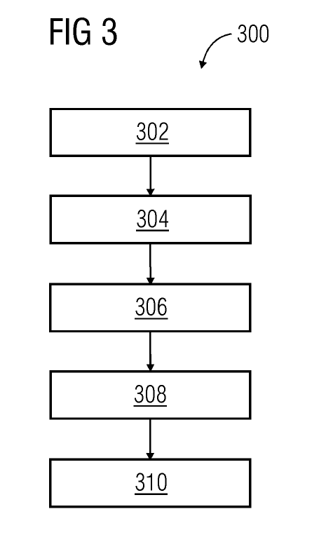

Referring to FIG. 3, a flowchart for determining abstraction level specific importance of one or more requirements of the project is depicted.

At act 302 of the flowchart depicted in FIG. 3, a dependency graph is created for the one or more requirements of the project. The exemplary dependency graph 100 is depicted in FIG. 1. Methods for creating or plotting the dependency graph from the one or more requirements are explained in preceding figures.

At act 304 of the flowchart depicted in FIG. 3, eigenvector centrality of the one or more requirements of the project is evaluated. The eigenvector centrality of the one or more requirements represented in the dependency graph, which is specifically for a level of abstraction of the project, is evaluated by using power iteration algorithms known in the state of the art. The power iteration algorithms may include, but not limited to, a PageRank algorithm. In another embodiment, the eigenvector centralities of all the requirements are normalized, using normalization methods known in the state of the art, such that a sum of the eigenvector centrality of all the requirements is 1.

At act 306 of the flowchart of FIG. 3, closeness centrality is evaluated for the one or more requirements represented in the dependency graph. The one or more requirements represent one or more nodes in the dependency graph. The closeness centrality is evaluated for a node by finding shortest path from the node to rest of the nodes of the one or more nodes representing the one or more requirements in the dependency graph. A shortest path score or closeness score for the node or the requirement is evaluated from the following equation 6.

s=1/a (6)

In equation 6, ‘s’ represents the shortest path score or the closeness score and ‘a’ is an average of path length from the node or the requirement to every other node or requirement of the dependency graph. From equation 6, it is evident that if the average path length (a) is high, then the closeness score (s) will be low and if the average path length (a) is low, then the closeness score (s) will be high. The closeness score (s) gives an insight into an extent to which the requirement is dependent on various dependency depicted in the dependency graph. In another embodiment, the closeness scores (s) of all the requirements are normalized, using normalization methods known in the state of the art, such that a sum of the closeness scores (s) of all the requirements is 1.

At act 308 of the flowchart depicted in FIG. 3, betweenness centrality for the one or more requirements is evaluated. The betweenness centrality for a requirement is evaluated as a number of shortest paths that passes through the requirement, in the dependency graph, in proportion of total number of shortest paths, for the one or more requirements, available in the dependency graph. The betweenness centrality gives an insight on the importance of a requirement in terms of the intermediacy in the realization of various dependency chains of requirements. In another embodiment, the betweenness centralities of all the requirements are normalized, using normalization methods known in the state of the art, such that a sum of the betweenness centrality of all the requirements is 1.

At act 310 for determining abstraction level specific importance of the one or more requirements of the project depicted in FIG. 3, an aggregate measure (g) of importance is evaluated for the one or more requirements from the eigenvector centrality, the closeness centrality, and the betweenness centrality. The aggregate measure (g) of importance is evaluated for a requirement from the following equation 7.

g=α*e+β*s+γ*b (7)

In equation 7, e, represents the eigenvector centrality, s represents the closeness centrality, and b represents the betweenness centrality of the requirement. Also, in the equation 7 α, β, and γ represent tunable parameters. In one embodiment, the tunable parameters α, β, and γ are chosen such that a sum of the tunable parameters α, β, and γ is 1. The aggregate measure (g) of importance for the one or more requirements evaluated from the equation 7 provides an insight into any conflicts that might negatively affect the project plan due to the individual views of the various stakeholders, team members, developers, or architects at various levels of abstraction of the project.

It is evident from the foregoing description that the embodiments disclose methods and systems for analyzing one or more requirements at one or more levels of abstraction of a project.

The present embodiments also disclose methods and systems for determining the volatile scores for the one or more requirements at a specific level of abstraction of a project. The embodiments provide methods for determining abstraction level specific importance of one or more requirements of the project.

The methods and systems disclosed provide an efficient and user friendly technique for quantifying the volatility also the importance factor for all the requirements of a project at various levels of abstraction.

While the present invention has been described in detail with reference to certain embodiments, it may be appreciated that the present invention is not limited to those embodiments. In view of the present disclosure, many modifications and variations would present themselves, to those of skill in the art without departing from the scope of various embodiments of the present invention, as described herein. The scope of the present invention is, therefore, indicated by the following claims rather than by the foregoing description. All changes, modifications, and variations coming within the meaning and range of equivalency of the claims are to be considered within their scope.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for analyzing one or more requirements at one or more levels of abstraction of a project, the method comprising:
plotting one or more dependency from the one or more requirements at the one or more levels of abstraction;
determining vulnerability of the one or more requirements from the one or more dependency graphs;
determining influence of the one or more requirements from the one or more dependency graphs;
evaluating one or more vulnerability scores for the one or more requirements, wherein the one or more vulnerability scores are evaluated from the vulnerability and the influence of the one or more requirements;
evaluating one or more influence scores for the one or more requirements, wherein the one or more influence scores are evaluated from the vulnerability and the influence of the one or more requirements; and
determining one or more volatile scores for the one or more requirements from the one or more vulnerability scores and the one or more influence scores.

2. The method according to claim 1 further comprising:
receiving the one or more requirements and dependency data from at least one user.

3. The method according to claim 1 further comprising:
evaluating an adjacent matrix for the one or more dependency graphs for evaluating the one or more vulnerability scores and the one or more influence scores.

4. The method according to claim 3 further comprising:
evaluating a transpose of the adjacent matrix for the one or more dependency graphs for evaluating the one or more vulnerability scores and the one or more influence scores.

5. The method according to claim 1 further comprising:
comparing the one or more vulnerability scores with a predefined threshold limit of vulnerability score for the project before determining the one or more volatile score for the one or more requirements.

6. The method according to claim 1 further comprising:
comparing the one or more influence scores with a predefined threshold limit of influence score for the project before determining the one or more volatile score for the one or more requirements.

7. A system for analyzing one or more requirements at one or more levels of abstraction of a project, the system comprising:
one or more plotters for plotting one or more dependency graphs from the one or more requirements at the one or more levels of abstraction;
one or more processors for determining vulnerability and influence of the one or more requirements from the one or more dependency graphs; and
one or more iteration modules for evaluating one or more vulnerability scores for the one or more requirements and one or more influence scores for the one or more requirements.

8. The system according to claim 7, wherein the one or more processors also evaluates an adjacent matrix for the one or more dependency graphs.

9. The system according to claim 8, wherein the one or more processors evaluates a transpose of the adjacent matrix for the one or more dependency graphs.

10. A method for determining abstraction level specific importance of one or more requirements of a project, the method comprising:
plotting one or more dependency graphs from the one or more requirements at the one or more levels of abstraction;
determining one or more eigenvector centralities for the one or more requirements from the one or more dependency graphs;
determining one or more closeness scores for the one or more requirements from the one or more dependency graphs;
determining one or more betweenness centralities for the one or more requirements from the one or more dependency graphs; and
evaluating one or more aggregate measures of importance for the one or more requirements from the one or more eigenvector centralities, the one or more closeness scores and the one or more betweenness centralities.

11. The method according to claim 10 further comprising:
finding a shortest path between a first requirement of the one or more requirements and a second requirement of the one or more requirements from the one or more dependency graphs before determining the one or more closeness scores.

12. The method according to claim 11 further comprising:
identifying number of shortest path passing through a requirement of the one or more requirements before determining the one or more betweenness centralities.

13. The method according to claim 10 further comprising:
defining one or more tunable parameters before evaluating the one or more aggregate measures of importance for the one or more requirements.
